(19) United States
(12) Patent Application Publication
(10) Pub. No.: US 2019/0076767 A1
(43) Pub. Date: Mar. 14, 2019

(54) FILTER DEVICE AND METHOD MANUFACTURING THE SAME

(71) Applicant: KYOSAN DENKI CO., LTD., Koga-city (JP)

(72) Inventors: Junko ISHII, Koga-city (JP); Katsuhisa YAMADA, Koga-city (JP)

(21) Appl. No.: 16/124,364

(22) Filed: Sep. 7, 2018

(30) Foreign Application Priority Data
Sep. 14, 2017 (JP) 2017-177020

(51) Int. Cl. B01D 39/16; B01D 29/11; B01D 35/00

(52) U.S. Cl. CPC B01D 39/163; B01D 29/114; B01D 2239/10; B01D 2239/0636; B01D 2239/0672; B01D 35/005

(57) ABSTRACT

The filter device has a high-temperature filter medium and a low-temperature filter medium. The high-temperature filter medium includes a high-temperature resin that melts above a first melting-temperature. The low-temperature filter medium includes a low-temperature resin which melts above a second melting-temperature which is lower than the first melting-temperature. The low-temperature filter medium is disposed in a layer in which a temperature for forming a welded portion is hard to rise. In the welded portion, both the high-temperature resin and the low-temperature resin are welded. A welding step supplies heat so that heat is transferred from the high-temperature filter medium to the low-temperature filter medium. In the welding step, melted resins are cured to form the welded portion after melting both the high-temperature resin and the low-temperature resin.

### CROSS REFERENCE TO RELATED APPLICATION

The present application is based on and claims the benefit of priority of Japanese Patent Application No. 2017477020, filed on Sep. 14, 2017, the disclosure of which is incorporated herein by reference.

### TECHNICAL FIELD

The disclosure in this specification relates to a filter device, and a method for manufacturing the same.

### BACKGROUND ART

JP2010-19151A discloses a filter device. The filter device has a filter medium including a plurality of layers. These layers are formed by laminating a plurality of filter media or by changing production conditions of the filter material. The filter medium comprising a plurality of layers is welded at the edges.

### SUMMARY

In the prior art, incomplete welding may occur due to insufficient melting of the filter medium. For example, part of the filter medium may be peeled off due to delay in heat transfer for melting the filter medium or heat radiation. Further improvement is required on the filter device and a manufacturing method of the same in view of the above described viewpoints and/or not mentioned other viewpoints.

It is a disclosed object to provide a filter device in which incomplete welding is suppressed.

It is a disclosed object to provide a manufacturing method for a filter device in which incomplete welding is suppressed.

A filter device comprises a filtering part for filtering a fluid with a filter medium, and a welded portion to which the resin forming the filter medium is welded, wherein the filter medium having a high-temperature filter medium including a high-temperature resin that melts at equal to or higher than a first melting-temperature, and a low-temperature filter medium including a low-temperature resin that melts equal to or higher than a second melting-temperature, which is lower than the first melting-temperature, and wherein the high-temperature filter medium and the low-temperature filter medium are arranged in a stacked manner, and wherein the low-temperature filter medium is disposed in a layer of which a temperature for forming the welded portion hardly increases, and wherein both the high-temperature resin and the low-temperature resin are welded in the welded portion.

According to the disclosed filter device, the low-temperature resin included in the low-temperature filter medium melts at a temperature equal to or higher than the second melting-temperature which is lower than the first melting-temperature. The low-temperature resin included in the low-temperature filter medium tends to form a welded portion. The low-temperature filter medium is disposed in a layer in which a temperature for forming the welded portion hardly increases. Therefore, even when the high-temperature filter medium and the low-temperature filter medium are arranged in a laminated manner, the welded portion reliably connects the high-temperature filter medium and the low-temperature filter medium. As a result, incomplete welding is suppressed.

The disclosed method for manufacturing a filter device, the filter device comprises a filtering part for filtering a fluid with a filter medium, and a welded portion on which a resin forming the filter medium is welded. The method comprises: a preparative step of arranging a high-temperature filter medium and a low-temperature filter medium in a laminated manner, the high-temperature filter medium including a high-temperature resin that melts at equal to or higher than a first melting-temperature, and the low-temperature filter medium including a low-temperature resin that melts at equal to or higher than a second melting-temperature which is lower than the first melting temperature; and a forming step of forming the welded portion including: supplying heat so that heat is transferred from the high-temperature filter medium to the low-temperature filter medium; melting both of the high-temperature resin in the high-temperature filter medium and the low-temperature resin in the low-temperature filter medium; and curing a melted portion to form the welded portion.

According to the disclosed method of manufacturing a filter device, heat is supplied so that heat is transferred from the high-temperature filter medium to the low-temperature filter medium in the welding process. The low-temperature resin included in the low-temperature filter medium melts at or above the second melting-temperature which is lower than the first melting-temperature. The low-temperature resin included in the low-temperature filter medium tends to form a welded portion. Therefore, even when the high-temperature filter medium and the low-temperature filter medium are arranged in a laminated manner, both the high-temperature resin and the low-temperature resin are melted, and then the welding portions are formed by curing them. The welded portion reliably connects the high-temperature filter medium and the low-temperature filter medium. As a result, incomplete welding is suppressed.

The disclosed aspects in this specification adopt different technical solutions from each other in order to achieve their respective objectives. Reference numerals in parentheses described in claims and this section exemplarily show corresponding relationships with parts of embodiments to be described later and are not intended to limit technical scopes. The objects, features, and advantages disclosed in this specification will become apparent by referring to following detailed descriptions and accompanying drawings.

### BRIEF DESCRIPTION OF DRAWINGS

FIG. 1 is a block diagram showing a fuel supply device of a first embodiment;

FIG. 2 is a perspective view showing a filter device and a fuel pump;

FIG. 3 is a perspective view showing a filter medium;

FIG. 4 is an enlarged view showing a mesh;

FIG. 5 is a cross-sectional view showing a fiber;

FIG. 6 is a cross-sectional view showing a method of manufacturing a filter device;

FIG. 7 is a graph showing a temperature change in a manufacturing method;

FIG. 8 is a perspective view showing a filter medium of a second embodiment;

FIG. 9 is a perspective view showing a filter medium of a third embodiment;

FIG. 10 is a perspective view showing a filter medium of a fourth embodiment;

FIG. 11 is a cross sectional view showing a fiber of a fifth embodiment;

FIG. 12 is an enlarged view showing a mesh of a sixth embodiment;

FIG. 13 is a block diagram showing a fuel supply device of a seventh embodiment;

FIG. 14 is a block diagram showing a fuel supply device of an eighth embodiment; and

FIG. 15 is a cross-sectional view showing a manufacturing method of the eighth embodiment.

### DESCRIPTION OF EMBODIMENTS

Hereinafter, a plurality of embodiments will be described with reference to the drawings. In some embodiments, parts that are functionally and/or structurally corresponding and/or associated are given the same reference numerals, or reference numerals with different hundred digit or more digits. For corresponding parts and/or associated parts, reference can be made to the description of other embodiments.

### First Embodiment

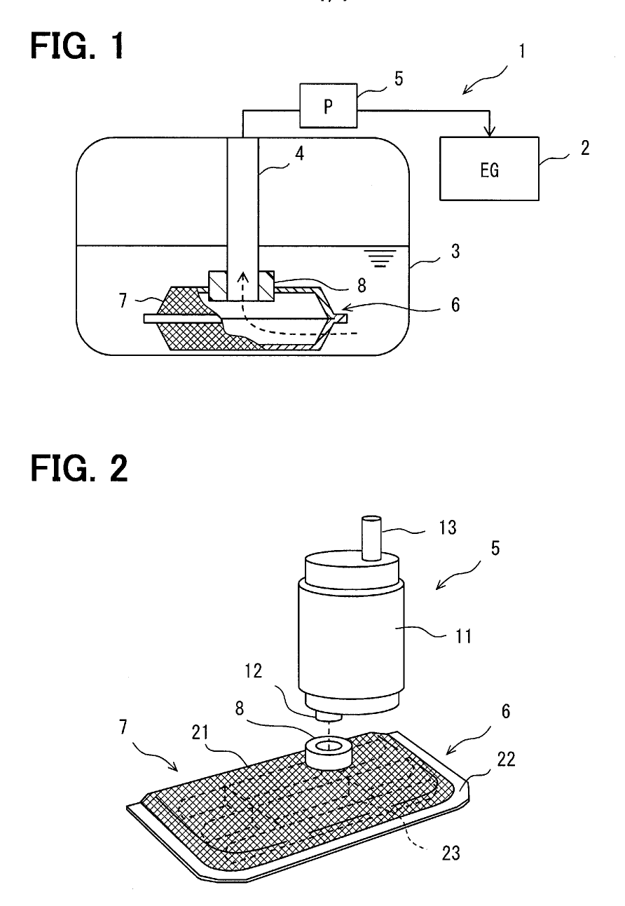

In FIG. 1, a fuel supply device 1 supplies fuel as a fluid to an internal combustion engine 2 (EG). The fuel supply device 1 is also called a fuel consumption device, a fuel injection device, or an internal combustion engine system. The fuel supply device 1 has a tank 3 for storing fuel. The fuel supply device 1 includes a pump 5 (P) that sucks out fuel from the tank 3 and supplies it to the internal combustion engine 2. The tank 3 has an outlet pipe 4 as an outlet passage for fuel. The pump 5 can be arranged in the tank 3 or outside the tank 3. Further, the pump 5 can be provided by various pumps such as an electric pump or a jet pump.

The fuel supply device 1 has a filter device 6. The filter device 6 is disposed in the tank 3. The filter device 6 is immersed in the fuel. The filter device 6 is provided at the open end of the outlet pipe 4 to remove foreign matter from the fuel passing therethrough. Dashed arrows indicate the flow of fuel. The filter device 6 is also called a strainer, an in-tank filter, or a suction filter.

The filter device 6 has a filter medium 7 for filtering fuel and a connecting pipe 8. The filter medium 7 is made of resin. The filter medium 7 is provided by a fabric or mesh and/or a nonwoven fabric. The filter medium 7 has a plurality of layers. The plurality of layers are formed by laminating meshes and/or nonwoven fabrics. The plurality of layers may be continuously formed by changing manufacturing conditions (including switching between a low-temperature resin and a high-temperature resin described later) of the resin fiber forming each layer. The filter medium 7 can be connected the plurality of layers by melting the material, bringing them into contact or mixing between the layers, and curing the melted portion again. The connecting tube 8 provides an outlet through a part of the filter medium 7. The connecting pipe 8 is made of resin. The connecting pipe 8 is provided integrally with the filter medium 7 by insert molding. The connecting pipe 8 provides a fluid passage communicating between an inside and an outside of the filter medium 7. The connecting pipe 8 may sandwich the filter medium 7 in a liquid-tight state between the connecting pipe 8 and a frame 23 described later.

In FIG. 2, an example of the pump 5 and the filter device 6 is shown. The pump 5 is an in-tank electric pump. The filter device 6 is disposed in the tank 3. The pump 5 has an electric motor 11. The pump 5 has a suction port 12 and a discharge port 13. The suction port 12 is fluidly connected to the connecting pipe 8. The discharge port 13 is connected to the internal combustion engine 2.

The filter device 6 is provided by a filter medium 7. The filter device 6 has a filtering part 21 for filtering fuel which is liquid by the filter medium 7. The filtering medium 7 has a property that fuel passes through the filtering part 21. The filter medium 7 is porous or a form of a woven fabric or a nonwoven fabric having a large number of clearances in the filtering part 21.

The filter device 6 has a welded portion 22 to which a resin forming the filter medium 7 is welded. The filter medium 7 loses the property of fuel permeation at the welded portion 22. The filter medium 7 is a massive structure in which the resin is closely packed in the welded portion 22. In the welded portion 22, both a high-temperature resin and a low-temperature resin which will be described later are welded.

The filter device 6 has a frame 23. The frame 23 keeps the filter medium 7 in a bag-like inflated state. The function of the frame 23 may be provided by at least one of high-temperature filter media 31, 33, 34, 35 described below.

The filter medium 7 is formed in a bag shape by folding one multilayer material. The welded portion 22 is formed so as to close the edge of the filter medium 7 formed in a bag shape. For example, the filter medium 7 is formed by folding the material to ½ and closing the three sides by the welded portion 22. The welded portion 22 is not limited to the edge, and may be formed in the intermediate portion. Further, the welded portion 22 may be formed on the four sides of the two overlapped filter medium 7, and the filter medium 7 may be closed like a bag.

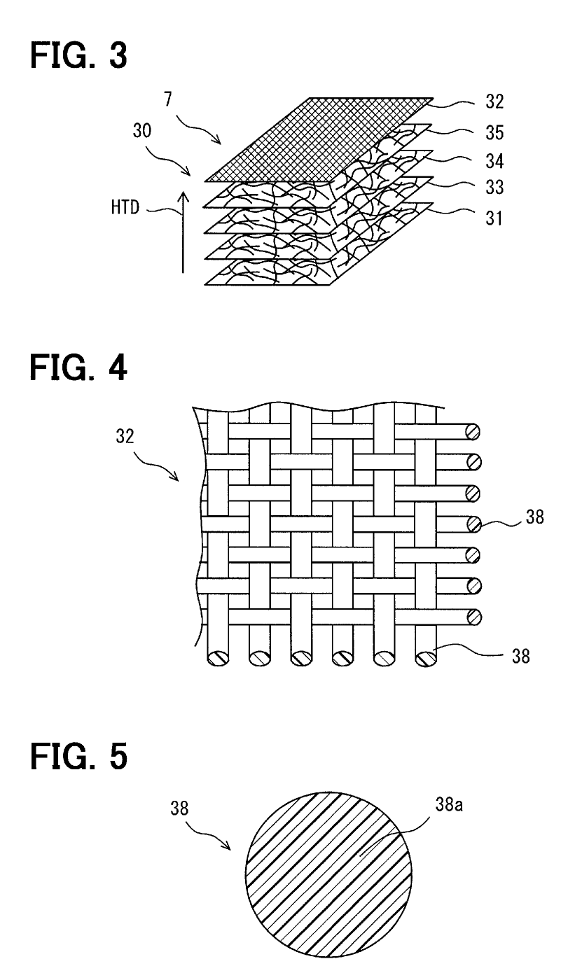

In FIG. 3, the material 30 providing the filter medium 7 is illustrated. The material 30 has a plurality of layers. The plurality of layers has at least an outer layer and an inner layer. When the material 30 has three or more layers, the plurality of layers has at least one intermediate layer. Each of these layers is designed to exhibit expected performance. The outer layer faces unfiltered fuel. The outer layer faces a wall surface of the tank 3. The outer layer, material, fiber diameter, weave and the like are selected so as to contribute to improve wear resistance of the filter device 6. The inner layer faces the fuel after filtration. The inner layer, material, fiber diameter, weave and the like are selected so as to contribute to improve filtering performance of the filter device 6. The inner layer, material, fiber diameter, weave and the like are selected so as to contribute to improve filtering performance of the filter device 6.

The material 30 has a high-temperature filter medium 31 as an inner layer. The high-temperature filter medium 31 includes a high-temperature resin that melts at equal to or higher than a first melting-temperature TH. The high-temperature filter medium 31 may include only the high-temperature resin. The high-temperature filter medium 31 is a nonwoven fabric. Fibers made of high-temperature resin are intertwined randomly in the nonwoven fabric.

The material 30 has a low-temperature filter medium 32 as an outer layer. The low-temperature filter medium 32 includes a low-temperature resin that melts at equal to or higher than a second melting-temperature TL which is lower than the first melting-temperature TH. The low-temperature filter medium 32 may include only a low-temperature resin. The low-temperature filter medium 32 may include both a high-temperature resin and a low-temperature resin. The low-temperature filter medium 32 is a mesh. Fibers made of the low-temperature resin are woven as warp and woof in the mesh. The mesh is also called a woven cloth or a woven fabric.

The material 30 has intermediate filter media 33, 34, 35 as intermediate layers. The intermediate filter media 33, 34, and 35 are nonwoven fabrics. The intermediate filter media 33, 34, 35 includes a high-temperature resin.

In the material 30, the high-temperature filter medium 31 and the low-temperature filter medium 32 are arranged in a laminated manner. In this embodiment, the high-temperature filter medium 31, the intermediate filter media 33, 34, 35, and the low-temperature filter medium 32 are arranged in this order in a laminated manner. In the material 30, the high-temperature filter medium 31 is disposed in the inner layer, and the low-temperature filter medium 32 is arranged in the outer layer.

In FIG. 3, the heat transfer direction HTD for forming the welded portion 22 is indicated by an arrow. In order to form the welded portion 22, the material 30 is given heat from a heat source. The heat of the heat source is transmitted along the heat transfer direction HTD. The heat transfer direction HTD occurs when there is a heat source on one side or the other side in the lamination direction of the filter medium 7. The heat transfer direction HTD occurs when there is a low-temperature portion on one side or the other side in the lamination direction of the filter medium 7. The low-temperature portion is provided, for example, by a mold, anvil, or horn to form the welded portion 22.

The low-temperature filter medium 32 is disposed in a layer in which the temperature for forming the welded portion 22 is hard to rise. The high-temperature filter medium 31 is disposed on an upstream side of the heat transfer direction HTD for forming the welded portion 22. The low-temperature filter medium 32 is disposed on a downstream side in the heat transfer direction HTD. The high-temperature filter medium 31 is arranged on an upstream side rather than the low-temperature filter medium 32 in the heat transfer direction HTD. The low-temperature filter medium 32 is arranged on a downstream side rather than the high-temperature filter medium 31 in the heat transfer direction HTD. A layer whose temperature is difficult to rise for forming the welded portion 22 may be caused by a position of the heat source or a low-temperature portion.

The high-temperature resin is PET (polyethylene terephthalate). The low-temperature resin is PP (polyethylene). The temperature difference between the first melting-temperature and the second melting-temperature can be set depending on the available resin material and the welding method for forming the welded portion 22 and the like. The temperature difference can be, for example, about 70 degrees Celsius. The low-temperature resin may be provided by low melting point PET instead of PP.

FIG. 4 shows a mesh providing a low-temperature filter medium 32. The mesh is a fabric in which a plurality of monofilaments 38 are arranged regularly. The warp and woof forming the mesh is provided by the plurality of monofilaments 38.

FIG. 5 shows a cross section of monofilament 38 providing the low-temperature filter medium 32. The monofilament 38 is formed only by the low-temperature resin 38a.

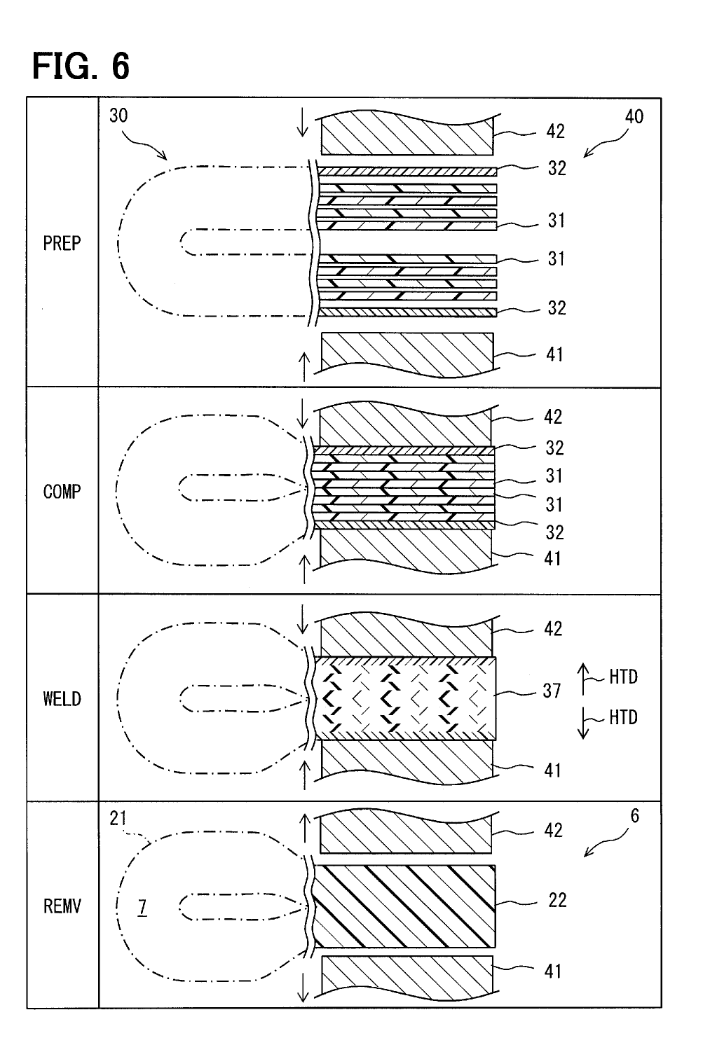

FIG. 6 shows a change in cross section in a plurality of steps included in the manufacturing method of the filter device. The manufacturing method of the filter device includes a preparative step PREP, a pressurization step COMP, a welding step WELD, and a discharge step REMV.

The preparative step PREP includes a step of preparing a high-temperature filter medium 31 and a low-temperature filter medium 32. The preparative step PREP includes folding the material 30 including a plurality of layers, laminating an edge of the material 30 and the other edge of the material 30, and attaching overlapped edges of the material 30 to the welding device 40. The material 30 is disposed between the anvil 41 and the horn 42 of the welding device 40. In the preparative step PREP, the high-temperature filter medium 31 is arranged inside and the low-temperature filter medium 32 is arranged outside. As a result, the low-temperature filter medium 32 is located outside than the high-temperature filter medium 31. In a complete form of the filter device, the low-temperature filter medium 32 is located more outside than the high-temperature filter medium 31. In the preparation step PREP, the high-temperature filter medium 31 and the low-temperature filter medium 32 are arranged in a laminated manner. In the preparing step PREP, the high-temperature filter medium 31 is arranged on an upstream side in the heat transfer direction HTD in the welding step WELD. In the preparing step PREP, the low-temperature filter medium 32 is arranged on a downstream side in the heat transfer direction HTD in the welding step WELD. Here, the words “upstream” and “downstream” can be clearly defined by relative locations of the high-temperature filter medium 31 and the low-temperature filter medium 32 in the heat transfer direction HTD.

The welding device 40 is an ultrasonic welding device. The anvil 41 provides a base. The horn 42 is a vibration exciter which applies ultrasonic vibration to the material. The edges of the material 30 are sandwiched by the welding device 40.

The pressing step COMP pressurizes the overlapped edges of the material 30. In the pressurizing step COMP, the material 30 is fixed by the welding device 40. In this state, the plurality of filter media 31 and 32 holds the shape of fibers and is in a state of being in close contact with each other by pressurization.

The welding step WELD applies ultrasonic vibration to the material 30 while pressurizing the material 30. The welding step WELD applies ultrasonic waves to the edge of the material 30 via the horn 42. The welding step WELD is an ultrasonic welding step in which ultrasonic waves are applied to a laminate including the high-temperature filter medium 31 and the low-temperature filter medium 32. The ultrasonic vibration generates frictional heat between the resin article fixed by the anvil 41 and the resin article excited by the horn 42. The frictional heat rises during the welding step WELD and is transmitted toward the anvil 41 and the horn 42. Therefore, during the welding step WELD, the heat transfer direction HTD of heat for welding occurs. In the downstream of this heat transfer direction THD, there is a layer of which a temperature for forming the welded portion 22 hardly rises. The layer whose temperature hardly rises is provided by the low-temperature filter medium 32.

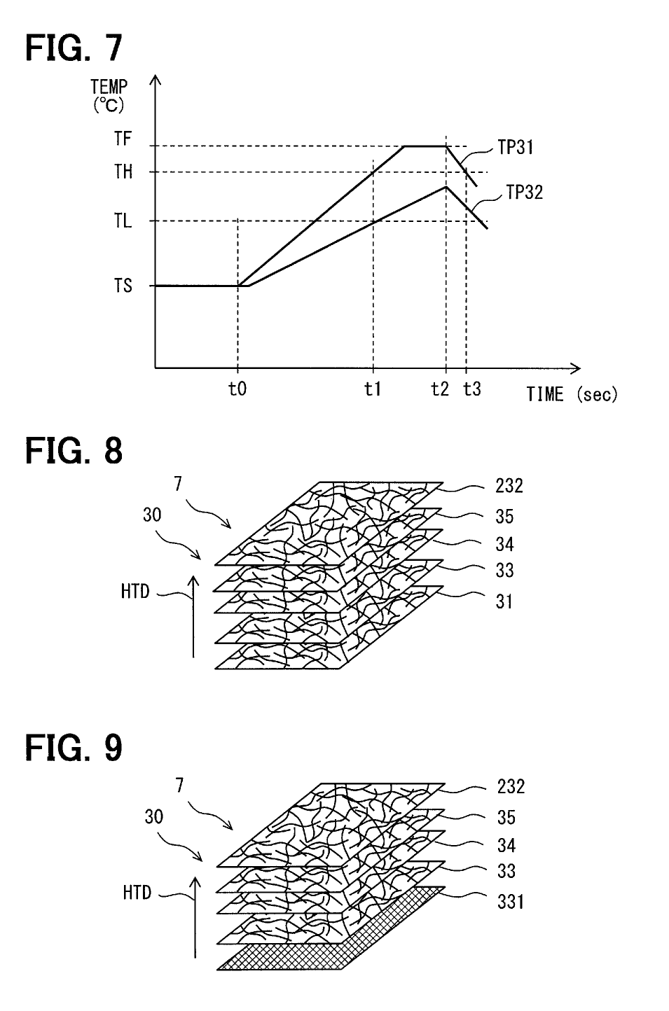

FIG. 7 shows changes in the temperature TP31 of the high-temperature filter medium 31 and the temperature TP32 of the low-temperature filter medium 32 in the welding step WELD. Heating is started from the initial temperature TS and the temperature rises during the welding step WELD. The second melting temperature TL is lower than the first melting temperature TH (TL<TH).

The welding step WELD starts at time t0. When ultrasonic waves are applied, the temperature TP31 gradually increases. At time t1, the temperature TP31 exceeds the first melting-temperature TH. As a result, the high-temperature resin melts. The temperature TP31 is maintained at the final temperature TF. At time t2, when the welding step WELD ends, the temperature TP31 gradually decreases. At time t3, the temperature TP31 becomes lower than the first melting-temperature TH. As a result, the high-temperature resin is cured, i.e., the high-temperature resin is hardened again.

The temperature TP32 rises gradually slightly behind the waveform of the temperature TP31. At time t1, the temperature TP32 exceeds the second melting-temperature TL. As a result, the low-temperature resin melts. The temperature TP32 and the temperature TP31 becomes higher than the respective melting temperatures TH and TL at substantially the same time. At time t2, when the welding step WELD ends, the temperature TP32 gradually decreases, and the low-temperature resin is cured, i.e., the low-temperature resin is hardened again.

Therefore, in the welding step WELD, the low-temperature resin is heated to reach the second melting-temperature TL or higher during a period in which the high-temperature resin reaches the first melting-temperature TH or higher, that is, between times t1 and t3. In other words, the welding step WELD increases a temperature of the low-temperature resin to reach equal to or higher than the second melting-temperature TL, during a period in which a temperature of the high-temperature resin reaches equal to or higher than the first melting-temperature TH. In other words, the welding step WELD melts the low-temperature resin during a time period the high-temperature resin is melted. At the same time as the high-temperature resin fiber of the high-temperature filter medium 31 melts, the low-temperature resin fiber of the low-temperature filter medium 32 melts. As a result, the high-temperature resin and the low-temperature resin are brought into contact in a molten state. The molten high-temperature resin does not wrap the low-temperature resin fiber, but the molten high-temperature resin and the molten low-temperature resin come into contact. In other words, the high-temperature resin in a flowing state and the low-temperature resin in a flowing state come into contact, and furthermore, they flow. After this, both the high-temperature resin and the low-temperature resin are cured. Both the high-temperature resin and the low-temperature resin are hardened again. Therefore, both the high-temperature resin and the low-temperature resin are welded in the welded portion.

Returning to FIG. 6, the welding step WELD provided by ultrasonic welding supplies heat so that heat is transferred from the high-temperature filter medium 31 to the low-temperature filter medium 32. The welding step WELD melts both the high-temperature resin in the high-temperature filter medium 31 and the low-temperature resin in the low-temperature filter medium 32. In this state, the plurality of filter media 31 and 32 are in a state of being bonded to each other and integrated as a continuous resin material by being hardened again after the fibers are melted. In the welding step, after melting both the high-temperature resin and the low-temperature resin, the melted portion is cured to form the welded portion. As a result, the welding step WELD forms the welded portion 22. In this state, the plurality of filter media 31 and 32 are in a state of being integrated with a continuous resin material. The welding step WELD forms contact traces with the anvil 41 and/or the horn 42 in the welded portion 22. The welding step WELD forms a contact trace with at least the horn 42 for ultrasonic welding at the welded portion 22. The contact trace depends on the surface shape formed on the anvil 41 or the horn 42. The contact trace is left as a twill weave patterned surface, a flat weave patterned surface, a flat surface, and the like.

According to this embodiment, the low-temperature resin contained in the low-temperature filter medium 32 melts at the second melting-temperature TL which is lower than the first melting-temperature TH. Therefore, the low-temperature resin contained in the low-temperature filter medium 32 tends to form a welded portion. Moreover, the low-temperature filter medium 32 is disposed in a layer in which the temperature for forming the welded portion hardly rises. Therefore, even when the high-temperature filter medium 31 and the low-temperature filter medium 32 are arranged in a laminated manner, the welded portion reliably connects the high-temperature filter medium 31 and the low-temperature filter medium 32. As a result, incomplete welding is suppressed.

According to this embodiment, in the welding step WELD, heat is supplied so that heat is transferred from the high temperature filter medium 31 to the low temperature filter medium 32. The low temperature resin contained in the low temperature filter medium 32 melts at a temperature higher than the second melting temperature TL which is lower than the first melting temperature TH. The low-temperature resin included in the low-temperature filter medium 32 tends to form the welded portion 22. Therefore, even when the high-temperature filter medium 31 and the low-temperature filter medium 32 are arranged in a laminated manner, both the high-temperature resin and the low-temperature resin are melted, and then the welding portions are formed by curing them. The welded portion 22 reliably connects the high-temperature filter medium 31 and the low-temperature filter medium 32. As a result, incomplete welding is suppressed.

### Second Embodiment

This embodiment is a modification in which the preceding embodiment is a base fundamental form. In the above embodiment, the low-temperature filter medium 32 on an outer layer is provided by the mesh. Alternatively, the outer layer may be a nonwoven fabric. FIG. 8 shows a low-temperature filter medium 232 made of nonwoven fabric.

### Third Embodiment

This embodiment is a modification in which the preceding embodiment is a base fundamental form. In the above embodiment, the high-temperature filter medium 31 on an inner layer is provided by the nonwoven fabric. Alternatively, the inner layer may be a mesh. FIG. 9 shows a high-temperature filter medium 331 made of a mesh.

### Fourth Embodiment

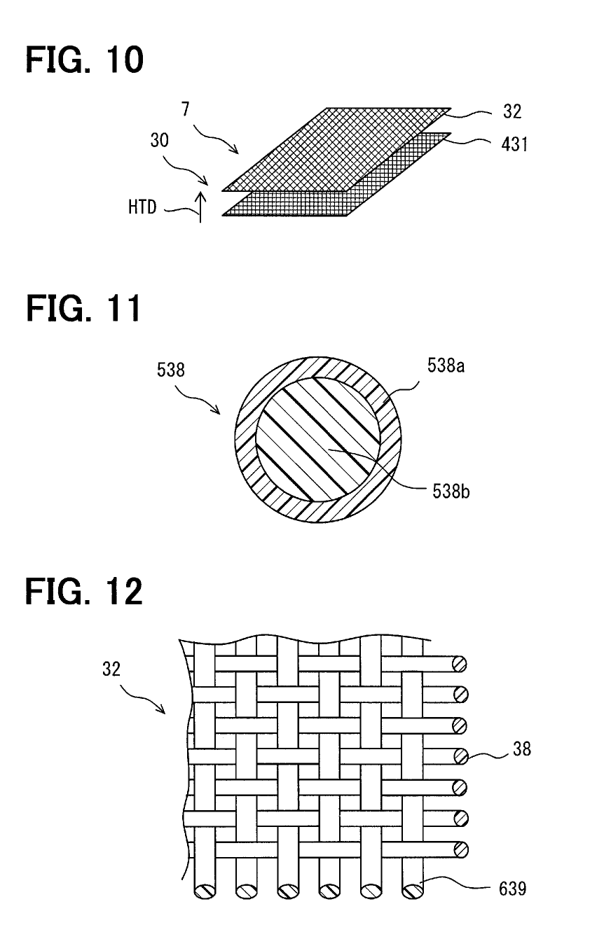

This embodiment is a modification in which the preceding embodiment is a base fundamental form. In the above embodiment, either one or both of the inner layer and the outer layer is provided by a nonwoven fabric. Further, in the above embodiment, the material 30 is a laminate of three or more layers. Alternatively, both the inner layer and the outer layer may be provided by a mesh. Further, the material 30 can be provided by a laminate of two or more layers. FIG. 10 shows a high-temperature filter medium 431 made of a mesh disposed on the inner layer. Further, in this embodiment, the intermediate filter media 33, 34 and 35 are not provided.

### Fifth Embodiment

This embodiment is a modification in which the preceding embodiment is a base fundamental form. In the above embodiment, the low-temperature filter medium 32 is provided by the plurality of monofilaments 38. The monofilament 38 is made of the low-temperature resin 38a. Alternatively, the low-temperature filter medium 32 may be provided by core-sheath fibers 538. In FIG. 11, the core-sheath fiber 538 has a sheath made of a low-temperature resin 538a and a core made of a high-temperature resin 538b. By disposing the low-temperature resin 538a on the sheath, welding of the low-temperature filter medium 32 can be promoted. The high-temperature filter medium 31 may also be provided by a core-sheath fiber.

### Sixth Embodiment

This embodiment is a modification in which the preceding embodiment is a base fundamental form. In the above embodiment, the low-temperature filter medium 32 is provided by a plurality of monofilaments 38 made of a low-temperature resin. Alternatively, the low-temperature filter medium 32 may be provided by the monofilaments 38 made of the low-temperature resin and monofilaments 639 made of a high-temperature resin. In FIG. 12, the warp and the weft forming the mesh are provided by the monofilament 38 made of the low-temperature resin and the monofilament 639 made of the high-temperature resin.

### Seventh Embodiment

This embodiment is a modification in which the preceding embodiment is a base fundamental form. In the above embodiment, the filter device 6 is applied to the suction port of the electric pump 5. Alternatively, the filter device 6 can be applied to the suction side of various pump devices.

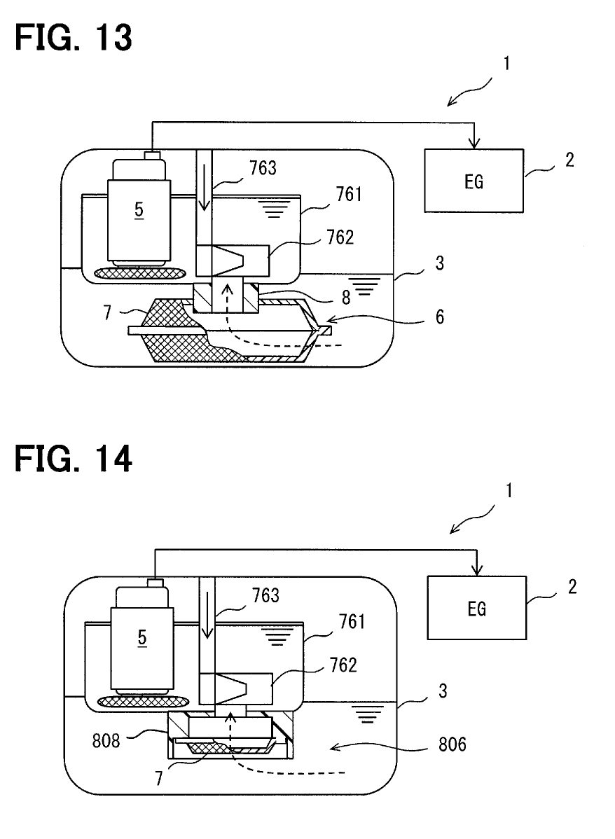

FIG. 13 shows a fuel supply device 1 according to this embodiment. The fuel supply device 1 has a sub tank 761. The sub tank 761 is disposed in the tank 3. The sub tank 761 suppresses the liquid surface fluctuation caused by a swing of the tank 3. The fuel supply device 1 has an auxiliary pump 762. The auxiliary pump 762 is provided by a jet pump powered by fuel flow. The auxiliary pump 762 has a fuel pipe 763 for supplying fuel as a power source. The fuel as a power source is provided by fuel for vapor discharge of the pump 5, surplus fuel, return fuel, and the like. The auxiliary pump 762 pumps the fuel in the tank 3 into the sub-tank 761. The filter device 6 is attached to the suction port of the auxiliary pump 762.

### Eighth Embodiment

This embodiment is a modification in which the preceding embodiment is a base fundamental form. In the above embodiment, the low-temperature filter medium 32 is disposed at both ends of the welded portion 222 in the laminating direction of the material 30. Alternatively, the low-temperature filter medium 32 may be disposed only at one end. The low-temperature filter medium 32 is disposed in a layer in which the temperature for forming the welded portion 22 hardly rises, so that incomplete welding can be suppressed.

In FIG. 14, the filter device 806 has a filter medium 7. The filter device 806 is directly welded to the connecting pipe 808. As a result, the filter device 806 is not in a bag shape. The filter device 806 has a connecting pipe 808 as a frame. The filter device 806 is stretched so as to cover the opening of the connecting pipe 808. The connecting pipe 808 is made of the high-temperature resin.

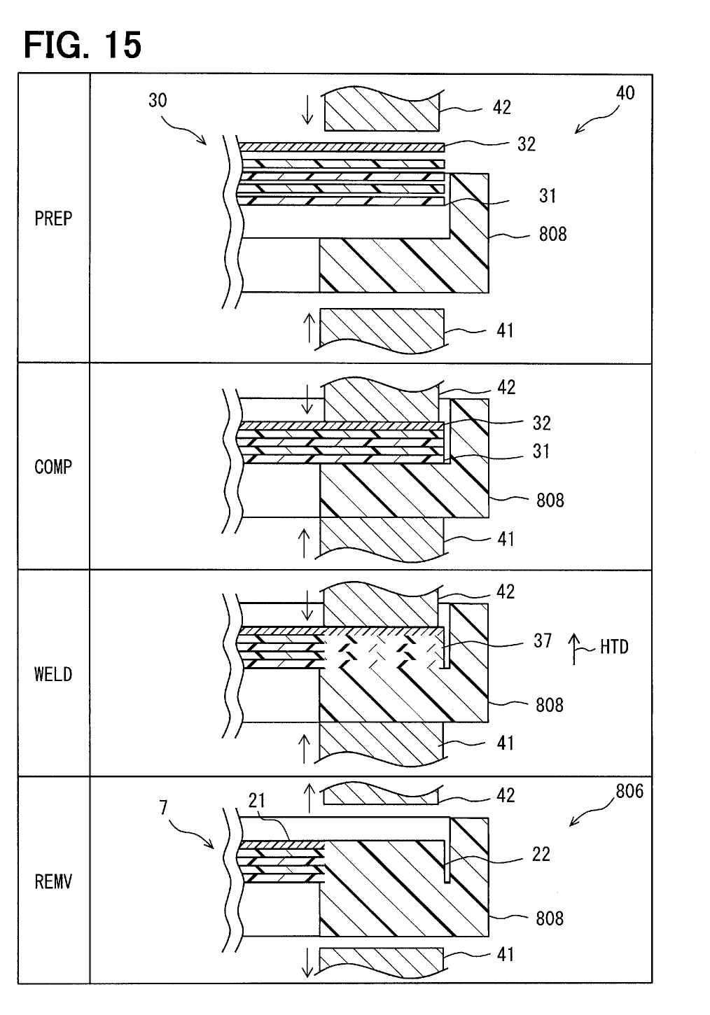

FIG. 15 shows a method of manufacturing the filter device 806. Also in this embodiment, ultrasonic welding is utilized.

The preparative step PREP arranges the connecting pipe 808 and the edge of the material 30 in a laminated manner. The high-temperature filter medium 31 is disposed so as to contact the connecting pipe 808. The low-temperature filter medium 32 is disposed so as to be in contact with the horn 42. Also in this embodiment, the low-temperature filter medium 32 is arranged to face the unfiltered fuel in the tank 3. Therefore, it can be said that the low-temperature filter medium 32 is arranged on the outer side. Also in this embodiment, the high-temperature filter medium 31 is arranged on the upstream side in the heat transfer direction HTD. The low-temperature filter medium 32 is disposed on a downstream side in the heat transfer direction HTD. The high-temperature filter medium 31 is arranged on an upstream side rather than the low-temperature filter medium 32 in the heat transfer direction HTD. The low-temperature filter medium 32 is arranged on a downstream side rather than the high-temperature filter medium 31 in the heat transfer direction HTD.

The compression step COMP pressurizes the material 30 and the connecting tube 808. The welding step supplies heat so that heat is transferred from the high-temperature filter medium to the low-temperature filter medium. In the welding step WELD, after melting the high-temperature resin in the high-temperature filter medium 31, the low-temperature resin in the low-temperature filter medium 32, and the resin in the connection tube 808, then, they are cured to form the welded portion 22. As a result, the high-temperature filter medium 31, the low-temperature filter medium 32, and the connecting pipe 808 are connected by a continuous resin material.

### Other Embodiments

The disclosure in this specification is not limited to the illustrated embodiment. The disclosure encompasses the illustrated embodiments and modifications by those skilled in the art based thereon. For example, the disclosure is not limited to the parts and/or combinations of elements shown in the embodiments. The disclosure can be implemented in various combinations. The disclosure may have additional parts that may be added to the embodiment. The disclosure encompasses omissions of parts and/or elements of the embodiments. The disclosure encompasses replacement or combination of parts and/or elements between one embodiment and another. The disclosed technical scope is not limited to the description of the embodiment. Several technical scopes disclosed are indicated by descriptions in the claims and should be understood to include all modifications within the meaning and scope equivalent to the descriptions in the claims.

In the above embodiments, ultrasonic welding is adopted to form the welded portion 22. Alternatively, various welding methods such as vibration welding, infrared welding, laser welding and the like can be adopted. Further, the welded portion 22 may be formed by a welding method not accompanied by cutting of the material, or it may be formed as a trace by a so-called fusing method involving cutting of the material.

In the above embodiment, since heat for welding is supplied from the inner layer, the high-temperature filter medium 31 is disposed in the inner layer and the low-temperature filter medium 32 is arranged in the outer layer. Alternatively, when heat for welding is supplied from the outer layer, the high-temperature filter medium 31 may be disposed in the outer layer and the low-temperature filter medium 32 may be disposed in the inner layer. Thereby, it is possible to dispose the high-temperature filter medium 31 in the upstream in the heat transfer direction HTD and the low-temperature filter medium 32 in the downstream in the heat transfer direction HTD. For example, the high-temperature filter medium 31 that generates heat by infrared welding may be disposed on an outer layer and the low-temperature filter medium 32 may be disposed on an inner layer distant from the high-temperature filter medium 31 as a heat source.

In the above embodiment, the filter device is a fuel filter for filtering fuel. Alternatively, the filter device can be used for a variety of applications. The filter device can be used for applications called screens, strainers and the like. For example, the filter device can be used for filtering various fluids such as water, fuel, air and gas.

What is claimed is:

1. A filter device comprising:
a filtering part for filtering a fluid with a filter medium, and
a welded portion to which the resin forming the filter medium is welded, wherein
the filter medium having:
a high-temperature filter medium including a high-temperature resin that melts at equal to or higher than a first melting-temperature; and
a low-temperature filter medium including a low-temperature resin that melts equal to or higher than a second melting-temperature, which is lower than the first melting-temperature, and wherein
the high-temperature filter medium and the low-temperature filter medium are arranged in a laminated manner, and wherein
the low-temperature filter medium is disposed in a layer of which a temperature for forming the welded portion hardly increases, and wherein
both the high-temperature resin and the low-temperature resin are welded in the welded portion.

2. The filter device claimed in claim 1, wherein
the high-temperature filter medium is disposed on an upstream side of the heat transfer direction for forming the welded portion, and wherein
the low-temperature filter medium is disposed on a downstream side in the heat transfer direction.

3. The filter device claimed in claim 2, wherein
the low-temperature filter medium is located outside than the high-temperature filter medium.

4. The filter device claimed in claim 1, wherein
the high-temperature filter medium includes only the high-temperature resin.

5. The filter device claimed in claim 1, wherein
the welded portion has a contact mark with a horn for ultrasonic welding.

6. A method for manufacturing a filter device, the filter device comprises
a filtering part for filtering a fluid with a filter medium, and
a welded portion on which a resin forming the filter medium is welded, the method comprising:
a preparative step of arranging a high-temperature filter medium and a low-temperature filter medium in a laminated manner, the high-temperature filter medium including a high-temperature resin that melts at equal to or higher than a first melting-temperature, and the low-temperature filter medium including a low-temperature resin that melts at equal to or higher than a second melting-temperature which is lower than the first melting temperature; and
a welding step of forming the welded portion including:
supplying heat so that heat is transferred from the high-temperature filter medium to the low-temperature filter medium;
melting both of the high-temperature resin in the high-temperature filter medium and the low-temperature resin in the low-temperature filter medium; and
curing a melted portion to form the welded portion.

7. The method for manufacturing a filter device claimed in claim 6, wherein
the preparative step comprises:
arranging the high-temperature filter medium on an upstream side of a heat transfer direction of heat in the forming step; and
arranging the low-temperature filter medium on a downstream side of the heat transfer direction.

8. The method for manufacturing a filter device claimed in claim 7, wherein
the welding step is an ultrasonic welding step of applying ultrasonic waves to a laminate including the high-temperature filter medium and the low-temperature filter medium.

9. The method for manufacturing a filter device claimed in claim 8, wherein
the preparative step arranges the low-temperature filter medium outside than the high-temperature filter medium.

10. The method for manufacturing a filter device claimed in claim 6, wherein
the welding step increases to reach a temperature of the low-temperature resin equal to or higher than the second melting-temperature during a period in which a temperature of the high-temperature resin reaches equal to or higher than the first melting-temperature.
